(19) United States
(12) Patent Application Publication
(10) Pub. No.: US 2026/0003384 A1
(43) Pub. Date: Jan. 1, 2026

(54) DSP CIRCUIT, TEST AND/OR MEASUREMENT INSTRUMENT, AND SIGNAL PROCESSING METHOD

(71) Applicant: Rohde & Schwarz GmbH & Co. KG, Muenchen (DE)

(72) Inventors: Andrew SCHAEFER, Muenchen (DE); Victor ARROYO, Madrid (ES)

(21) Appl. No.: 18/758,947

(22) Filed: Jun. 28, 2024

(51) Int. Cl. G06F 1/02; G06F 1/03; G06F 9/30

(52) U.S. Cl. CPC G06F 1/022; G06F 1/03; G06F 9/3001

(57) ABSTRACT

A digital signal processing (DSP) circuit is described. The DSP circuit includes a signal input, a signal encoding circuit, a generative circuit, and a DSP function circuit. The signal input is configured to receive at least one input signal. The signal encoding circuit is configured to process the at least one input signal, wherein the signal encoding circuit is configured to map the at least one input signal to at least one signal characterization parameter. The generative circuit is configured to generate a set of measurement data based on the at least one signal characterization parameter, wherein the set of measurement data includes at least one measurement value. The DSP function circuit is configured to provide a DSP functionality. The DSP function circuit is configured to process and/or combine the set of measurement data, thereby obtaining a set of expedited output data.

### FIELD OF THE DISCLOSURE

Embodiments of the present disclosure generally relate to a digital signal processing (DSP) circuit. Embodiments of the present disclosure further relate to a test and/or measurement instrument, and to a signal processing method of processing at least one input signal by a DSP circuit.

### BACKGROUND

Digital signal processing (DSP) is essentially ubiquitous in modern test and measurement instruments, wherein measurement signals are digitized by an analog-to-digital converter and afterwards processed by a DSP circuit.

The DSP circuit can provide a plurality of different functionalities that match the specific demands of the respective measurement to be conducted. However, certain DSP operations such as visualization, are computationally expensive, i.e. require a considerable amount of computational resources and/or computing time.

Thus, there is a need for a DSP circuit, a test and/or measurement instrument, and a signal processing method that allow to perform DSP functionalities in a more efficient manner.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a digital signal processing (DSP) circuit. In an embodiment, the DSP circuit comprises a signal input, a signal encoding circuit, a generative circuit, and a DSP function circuit. The signal input is configured to receive at least one input signal. The signal encoding circuit is configured to process the at least one input signal, wherein the signal encoding circuit is configured to map the at least one input signal to at least one signal characterization parameter. The generative circuit is configured to generate a set of measurement data based on the at least one signal characterization parameter, wherein the set of measurement data comprises at least one measurement value. The DSP function circuit is configured to provide a DSP functionality. The DSP function circuit is configured to process and/or combine the set of measurement data, thereby obtaining a set of expedited output data.

The term “provide a DSP functionality” is understood to denote that the DSP function circuit is configured to generate an output result that corresponds to a DSP operation being applied to the at least one input signal.

However, instead of applying the DSP operation directly to the at least one input signal, which may be computationally expensive, the DSP circuit according to the present disclosure has an accelerated processing path, namely the signal encoding circuit, the generative circuit, and the DSP function circuit.

In an embodiment, the signal encoding circuit maps the at least one input signal to at least one signal characterization parameter. In general, the number of possible signal characterization parameters is smaller than the number of possible input signals. In other words, the signal encoding circuit reduces the dimensionality of the at least one input signal before processing by the further circuits downstream of the signal encoding circuit.

Based on the at least one signal characterization parameter, the generative circuit generates a set of measurement data. Therein, the measurement data generated is measurement data computed based on the at least one signal characterization parameter rather than measurement data being directly measured. In other words, the set of measurement data corresponds to a “typical” set of measurement data for the type or class of the at least one input signal.

Thus, as will be described in more detail below, the set of measurement data can be obtained in a resource-efficient way by employing a lookup table or a machine-learning model that is trained to obtain the set of measurement data based on the at least one signal characterization parameter.

Thus, compared to the usual DSP approach, the set of measurement data can be obtained faster and/or with reduced computational resources, thereby reducing the measurement time and/or the power consumption of the DSP circuit.

In an embodiment, the DSP functionality circuit combines and/or further processes the set of measurement data, for example the individual measurement values, thereby obtaining the set of expedited output data.

In an embodiment, the set of expedited output data corresponds to output data that can be obtained by applying conventional DSP operations to the at least one output signal, but is obtained in a faster and/or more resource efficient manner, as already described above.

For example, the at least one signal characterization parameter may be at least one characteristic parameter that corresponds to at least one signal class. In other words, the signal encoding circuit may be configured to classify the at least one input signal. As another example, the signal encoding circuit may be configured to map the at least one input signal to a latent space having a reduced number of properties or a reduced number of latent coordinates. Accordingly, the at least one signal characterization parameter may be at least one latent coordinate. In a certain example, the signal encoding circuit may be or comprise an encoder portion of an autoencoder.

In an embodiment, the at least one input signal may comprise one input signal or a plurality of input signals.

In an embodiment of the present disclosure, the DSP functionality comprises at least one of visualizing the at least one input signal, applying arithmetic operations to the at least one input signal, applying mathematical operations to the at least one input signal, filtering the at least one input signal, or interpolating the at least one input signal. However, it is to be understood that the DSP functionality may be or comprise any other suitable DSP operation, and/or any combination of DSP operations, such as filtering and visualization.

In a certain example, the DSP functionality may comprise applying a mathematical operation to a plurality of input signals, such as determining a cross-correlation of the input signals, multiplying the input signals, etc.

According to an aspect of the present disclosure, the DSP circuit, for example, comprises a first signal path and a second signal path each being connected to the signal input, wherein the first signal path is configured to provide said DSP functionality, wherein the first signal path is configured to process the at least one input signal, thereby obtaining a set of conventional output data, and wherein the second signal path comprises the signal encoding circuit, the generative circuit, and the DSP function circuit. In other words, in the first signal path, a conventional DSP operation may be applied to the at least one input signal, while the second signal path provides an expedited DSP of the at least one input signal.

This combination of the first signal path and the second signal path is particularly advantageous, as all types of input signals can be processed reliably.

As will described in more detail hereinafter, the expedited processing by the second signal path is most reliable for input signals that can be mapped onto a defined set of signal characterization parameters, i.e. for input signals having low entropy (or “randomness”). This type of signals can be processed by the second signal path in a reliable, fast, and resource-efficient manner.

For input signals that have a high entropy (i.e. a high randomness), the second signal path may not provide particularly reliable results. However, this type of input signal can be processed by the first signal path, such that reliable measurement results or reliable output data is obtained even for input signals having high entropy.

In an embodiment, typical input signals that can be mapped onto the defined set of signal characterization parameters may be processed by the second signal path, while other types of input signals such as anomalous input signals may be processed by the first signal path.

In an embodiment, anomalous input signals or the output data associated with anomalous input signals may be highlighted in a visualization of the corresponding measurement data.

In an embodiment, output data that is obtained by the first signal path may be highlighted in a visualization of the corresponding measurement data.

In a further embodiment of the present disclosure, the first signal path and the second signal path are arranged in parallel to each other. Accordingly, the at least one input signal can be simultaneously or selectively processed by the first signal path and/or the second signal path.

According to another aspect of the present disclosure, the DSP circuit further comprises, for example, a control circuit, wherein the control circuit is configured to selectively activate the second signal path. In an embodiment, the control circuit may activate the second signal path if it is determined that the at least one input signal is suitable for expedited processing by the second signal path.

In an embodiment, the control circuit may be configured to determine an entropy parameter based on the at least one input signal. In general, the entropy parameter is a measure for the randomness of the at least one input signal. It has turned out that the randomness of the at least one input signal is a suitable measure for determining whether the at least one input signal qualifies for expedited processing by the second signal path.

In an embodiment, the control circuit may be configured to activate the second signal path if the entropy parameter determined is smaller than a predefined threshold. In other words, the second signal path may be activated if the randomness of the at least one input signal is below a certain threshold.

If the entropy parameter determined is greater than the predefined threshold, the at least one input signal may be processed by the first signal path.

In other words, the control circuit may be configured to (selectively) activate the first signal path if the entropy parameter determined is greater than the predefined threshold.

In an embodiment of the present disclosure, the generative circuit is configured to generate the set of measurement data based on a lookup table. In other words, the set of measurement data or the at least one measurement value may be selected from predefined measurement values stored in the lookup table, wherein each predefined measurement value may be associated with a certain value of the at least one signal characterization parameter. Thus, the set of measurement data can be obtained in a particularly fast and resource-efficient manner.

In a further embodiment of the present disclosure, the generative circuit comprises a machine-learning circuit, wherein the machine-learning circuit is pre-trained to generate the set of measurement data. More precisely, the machine-learning circuit may comprise a machine-learning model that is pre-trained to generate the set of measurement data based on the at least one signal characterization parameter.

Therein, the at least one signal characterization parameter may be an input quantity of the machine-learning circuit, while the set of measurement data corresponds to output quantities of the machine-learning circuit.

In an embodiment, the at least one signal characterization parameter may correspond to latent coordinates in a latent space. Accordingly, the machine-learning circuit may be pre-trained to generate the set of measurement data based on a latent space representation of the at least one input signal having reduced dimensionality.

According to an aspect of the present disclosure, the machine-learning circuit comprises, for example, a decoder portion of an autoencoder. It has turned out that the decoder portion of an autoencoder is a particularly suitable type of machine-learning model for generating the set of measurement data based on the at least one signal characterization parameter, for example for the at least one signal characterization parameter being a latent space parameter or a latent space coordinate.

Embodiments of the present disclosure further provide a test and/or measurement instrument. The test and/or measurement instrument comprises a DSP circuit according to any of the embodiments described above.

Regarding the advantages and further properties of the test and/or measurement instrument, reference is made to the explanations given above with respect to the DSP circuit, which also hold for the test and/or measurement instrument and vice versa.

In an embodiment, the test and/or measurement instrument may be an oscilloscope, a signal analyzer, a vector network analyzer, or a spectrum analyzer. However, it is to be understood that the test and/or measurement instrument may be established as any other suitable type of test and/or measurement instrument.

Embodiments of the present disclosure further provide a signal processing method of processing at least one input signal by a DSP circuit. In an embodiment, the signal processing method comprises the steps of
receiving, by a signal input, at least one input signal;
mapping, by a signal encoding circuit, the at least one input signal to at least one signal characterization parameter;
generating, by a generative circuit, a set of measurement data based on the at least one signal characterization parameter, wherein the set of measurement data comprises at least one measurement value; and
processing and/or combining, by a DSP function circuit being configured to provide a DSP functionality, the set of measurement data, thereby obtaining a set of expedited output data.

In an embodiment, the DSP circuit according to any of the embodiments described above and/or the test and/or measurement instrument according to any of the embodiments described above may be configured to perform any embodiment of the signal processing method.

Regarding the advantages and further properties of the signal processing method, reference is made to the explanations given above with respect to the DSP circuit and to the test and/or measurement instrument, which also hold for the signal processing method and vice versa.

According to an aspect of the present disclosure, the DSP functionality comprises, for example, at least one of visualizing the at least one input signal, applying arithmetic operations to the at least one input signal, applying mathematical operations to the at least one input signal, filtering the at least one input signal, or interpolating the at least one input signal. However, it is to be understood that the DSP functionality may be or comprise any other suitable DSP operation, and/or any combination of DSP operations, such as filtering and visualization.

In a certain example, the DSP functionality may comprise applying a mathematical operation to a plurality of input signals, such as determining a cross-correlation of the input signals, multiplying the input signals, etc.

In an embodiment of the present disclosure, the DSP circuit comprises a first signal path and a second signal path each being connected to the signal input, wherein the first signal path is configured to provide said DSP functionality, wherein the second signal path comprises the signal encoding circuit, the generative circuit, and the DSP function circuit, and wherein the signal processing method comprises the step of selectively processing the at least one input signal by the first signal path or the second signal path. In other words, in the first signal path, a conventional DSP operation may be applied to the at least one input signal, while the second signal path provides an expedited DSP of the at least one input signal.

This combination of the first signal path and the second signal path is particularly advantageous, as all types of input signals can be processed reliably.

Another aspect of the present disclosure provides, for example, that the second signal path is selectively activated by a control circuit. In an embodiment, the control circuit may activate the second signal path if it is determined that the at least one input signal is suitable for expedited processing by the second signal path.

In an embodiment, an entropy parameter may be determined by the control circuit. It has turned out that the randomness of the at least one input signal is a suitable measure for determining whether the at least one input signal qualifies for expedited processing by the second signal path.

In an embodiment of the present disclosure, the second signal path is activated if the entropy parameter determined is smaller than a predefined threshold. In other words, the second signal path may be activated if the randomness of the at least one input signal is below a certain threshold.

If the entropy parameter determined is greater than the predefined threshold, the at least one input signal may be processed by the first signal path.

In other words, the control circuit may be configured to (selectively) activate the first signal path if the entropy parameter determined is greater than the predefined threshold.

In a further embodiment of the present disclosure, the set of measurement data is generated based on a lookup table. In other words, the set of measurement data or the at least one measurement value may be selected from predefined measurement values stored in the lookup table, wherein each predefined measurement value may be associated with a certain value of the at least one signal characterization parameter. Thus, the set of measurement data can be obtained in a particularly fast and resource-efficient manner.

According to another aspect of the present disclosure, the generative circuit comprises, for example, a machine-learning circuit, wherein the machine-learning circuit is pre-trained to generate the set of measurement data. More precisely, the machine-learning circuit may comprise a machine-learning model that is pre-trained to generate the set of measurement data based on the at least one signal characterization parameter.

Therein, the at least one signal characterization parameter may be an input quantity of the machine-learning circuit, while the set of measurement data corresponds to output quantities of the machine-learning circuit.

In an embodiment, the at least one signal characterization parameter may correspond to latent coordinates in a latent space. Accordingly, the machine-learning circuit may be pre-trained to generate the set of measurement data based on a latent space representation of the at least one input signal having reduced dimensionality.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a test and/or measurement instrument according to an embodiment of the present disclosure;

FIG. 2 schematically shows an example of a DSP circuit of the test and/or measurement instrument of FIG. 1;

FIG. 3 shows a flow chart of a signal processing method according to an embodiment of the present disclosure; and

FIG. 4 shows an example histogram of measurement data obtained by the DSP of FIG. 2.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

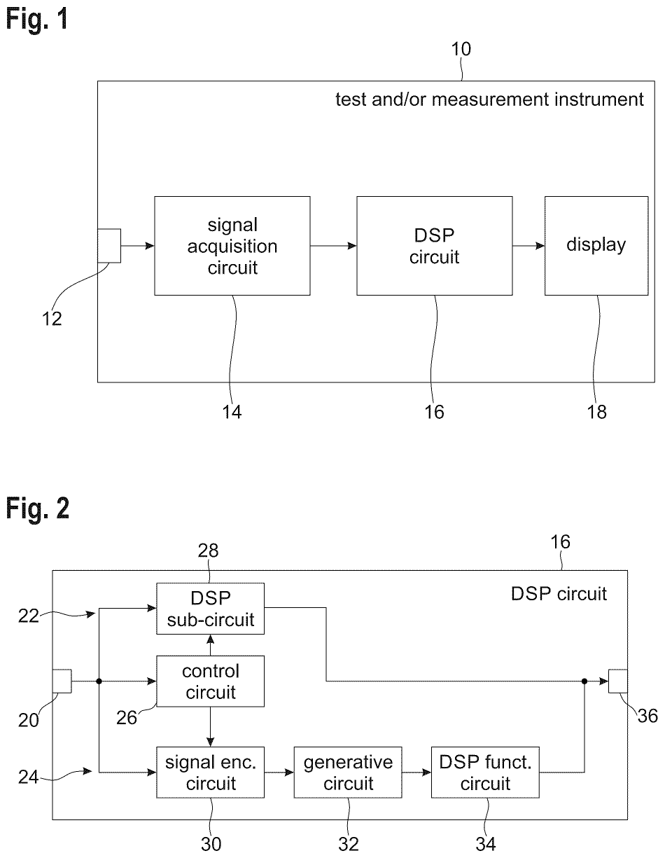

FIG. 1 schematically shows a test and/or measurement instrument 10 in accordance with an embodiment of the present disclosure. In general, the test and/or measurement instrument 10 is configured to perform tests and/or measurements on an electronic device under test. For example, the test and/or measurement instrument 10 may be an oscilloscope, a signal analyzer, a vector network analyzer, or a spectrum analyzer. However, it is to be understood that the test and/or measurement instrument 10 may be established as any other suitable type of test and/or measurement instrument.

In an embodiment, the test and/or measurement instrument 10 comprises a signal input 12 that is connectable to the device under test, wherein the signal input 12 is configured to receive at least one analog or digital signal from the device under test. The test and/or measurement instrument 10 further comprises a signal acquisition circuit 14 that is connected to the signal input 12 so as to receive the at least one analog or digital signal from the signal input 12.

In general, the signal acquisition circuit 14 is configured to pre-process the at least one analog or digital signal received from the signal input 12 for further processing downstream of the signal acquisition circuit 14, thereby obtaining at least one output signal being a digital signal. This pre-processing may comprise at least one of digitizing, filtering, interpolating, decimating, down-converting a frequency, mixing, saving in a memory, or any other suitable type of operation.

In an embodiment, the test and/or measurement instrument 10 further comprises a digital signal processing (DSP) circuit 16 that is connected to the signal acquisition circuit 14 so as to receive the at least one output signal of the signal acquisition circuit 14 as an input signal. It is noted that the at least one signal received by the DSP circuit 16 is referred to as “at least one input signal” hereinafter.

As will be described in more detail below, the DSP circuit 16 is configured to provide at least one DSP functionality, such as visualizing the at least one input signal, applying arithmetic operations to the at least one input signal, applying mathematical operations to the at least one input signal, filtering the at least one input signal, or interpolating the at least one input signal, etc.

In an embodiment, the test and/or measurement instrument 10 may further comprise a display 18 that is configured to display visualization data provided by the DSP circuit 16. It is noted that while the display 18 is shown to be integrated into the test and/or measurement instrument 10 in FIG. 1, the display 18 may alternatively or additionally be provided separately from the test and/or measurement instrument 10, and may be connected to the test and/or measurement instrument 10 via a suitable port.

An embodiment of the DSP circuit 16 is shown in in more detail in FIG. 2. The DSP circuit 16 comprises a signal input 20 that is connected to the signal acquisition circuit 14 so as to receive the at least one input signal. The DSP circuit 16 further comprises a first signal path 22, a second signal path 24, and a control circuit 26 that are each connected to the signal input 20 so as to receive the at least one input signal from the signal input 20. Therein, the first signal path 22 and the second signal path 24 are arranged in parallel to each other.

In an embodiment, the first signal path 22 comprises a DSP sub-circuit 28 that is connected to the signal input 20. In an embodiment, the second signal path 24 comprises a signal encoding circuit 30 that is connected to the signal input 20.

In an embodiment, the second signal path 24 further comprises a generative circuit 32 that is connected to the signal encoding circuit 30 downstream of the signal encoding circuit 30. Moreover, the second signal path 24 may comprise a DSP function circuit 34 that is connected to the generative circuit 32 downstream of the generative circuit 32.

The functionality of the first signal path 22 and of the second signal path 24 will be described in more detail below.

In an embodiment, the DSP circuit 16 further comprises a signal output 36 that is connected to both the first signal path 22 and the second signal path 24, more precisely to the DSP sub-circuit 28 and to the DSP function circuit 34, respectively.

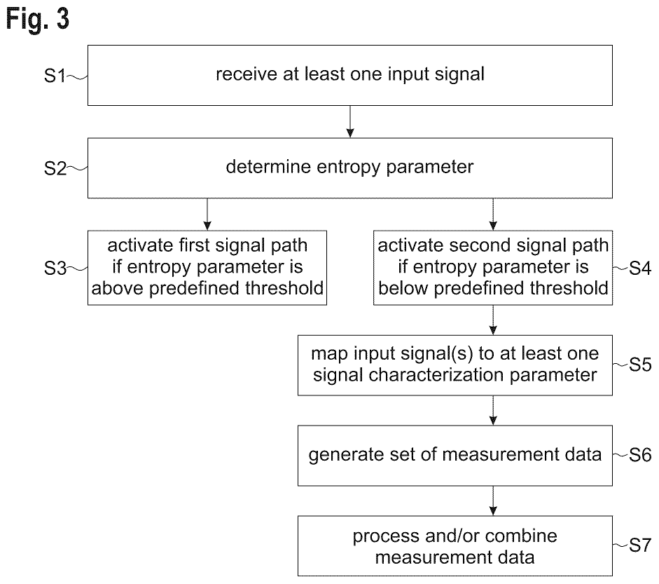

The test and/or measurement instrument 10 or the DSP circuit 16 is configured to perform a signal processing method of processing at least one input signal, an embodiment of which is described below with reference to FIG. 3.

At least one input signal is received by the signal input 20 (step S1). As already described above, the at least one input signal may be a digital output signal of the signal acquisition circuit 14.

An entropy parameter of the at least one input signal may be determined by the control circuit 26 (step S2). In general, the entropy parameter is a measure for the randomness of the at least one input signal, i.e. for the amount of uncertainty that is inherent to the at least one input signal e.g. with respect to consecutive samples.

The entropy of a random variable can be defined as

$$H ( X ) = - {\sum }_{x ∈ χ} p ( x ) log ( x ) .$$

Therein, p(x) is the probability of x taking the value χ, and the sum runs over all possible values χ.

The entropy parameter for the at least one input signal may be calculated analogously to the definition of the entropy given above.

The control circuit 26 may selectively activate the first signal path 22 or the second signal path 24 based on the entropy parameter determined.

If the entropy parameter is above a predefined threshold, the control circuit 26 may activate the first signal path 22, and the at least one input signal may be processed by the DSP sub-circuit 28 (step S3).

In general, the DSP sub-circuit 28 is configured to provide a DSP functionality, such as visualizing the at least one input signal, applying arithmetic operations to the at least one input signal, applying mathematical operations to the at least one input signal, filtering the at least one input signal, or interpolating the at least one input signal.

In other words, the first signal path 22 provides a conventional DSP of the at least one input signal, i.e. a conventional DSP operation that is applied directly to the at least one input signal.

In a certain example, the DSP sub-circuit 28 may generate visualization data based on the at least one input signal, and the visualization data may be forwarded to the display 18 via the signal output 36.

If the entropy parameter is below the predefined threshold, the control circuit 26 may activate the second signal path 24 (step S4).

The at least one input signal is mapped to at least one signal characterization parameter by the signal encoding circuit 30 (step S5).

For example, the at least one signal characterization parameter may be at least one characteristic parameter that corresponds to at least one signal class. In other words, the signal encoding circuit 30 may be configured to classify the at least one input signal.

In order to classify the at least one input signal, the signal encoding circuit 30 may employ any suitable type of algorithm and/or any suitable type of machine-learning model being pre-trained to classify the at least one input signal.

As another example, the signal encoding circuit 30 may be configured to map the at least one input signal to a latent space having a reduced number of properties or a reduced number of latent coordinates. Accordingly, the at least one signal characterization parameter may be at least one latent coordinate.

In an example, the signal encoding circuit 30 may be or comprise an encoder portion of an autoencoder being configured or pre-trained to transform the at least one input signal to a latent space representation.

A set of measurement data is generated by the generative circuit 32 based on the at least one signal characterization parameter (step S6). Therein, the set of measurement data may comprise at least one measurement value, for example a plurality of measurement values.

The measurement data generated is measurement data computed based on the at least one signal characterization parameter rather than measurement data being directly measured, i.e. the generative circuit 32 is functionally different from the DSP sub-circuit 28. In an embodiment, the set of measurement data generated by the generative circuit 32 corresponds to a “typical” set of measurement data for the type or class of the at least one input signal.

For example, the generative circuit 32 may generate the set of measurement data based on a lookup table, i.e. by selecting the measurement values from predefined measurement values stored in the lookup table based on the at least one signal characterization parameter. In an embodiment, each predefined measurement value may be associated with a certain value of the at least one signal characterization parameter.

As another example, the generative circuit 32 may comprises a machine-learning circuit, wherein the machine-learning circuit is pre-trained to generate the set of measurement data. More precisely, the machine-learning circuit may comprise a machine-learning model that is pre-trained to generate the set of measurement data based on the at least one signal characterization parameter. For example, the machine-learning circuit may be or comprise a decoder portion of an autoencoder.

Therein, the at least one signal characterization parameter may correspond to latent coordinates in a latent space. Accordingly, the machine-learning circuit may be pre-trained to generate the set of measurement data based on a latent space representation of the at least one input signal.

In general, the set of measurement data and specifically the individual measurement values depend on the type of the DSP functionality that is to be provided.

For example, if the at least one input signal is to be visualized, the individual measurement values may correspond to visualization data for the at least one input signal currently processed or for individual portions of the at least one input signal currently processed.

Accordingly, in a certain example, the lookup table describe above may comprise a plurality of pre-rendered visualizations, and the generative circuit 32 may select the appropriate pre-rendered visualizations based on the at least one signal characterization parameter.

As another example, if the at least one input signal is to be interpolated, the individual measurement values may correspond to the values of the samples of the at least one input signal and to values of interpolated samples between these samples.

For low-entropy signals being associated with a fixed hardware, the number of possible values of the interpolated samples may be restricted to a certain number of typical combinations.

Accordingly, the lookup table and/or machine-learning model described above can be used in order to interpolate the at least one input signal without actually performing the interpolation calculations. This allows to maintain high acquisition rates even for interpolated time cases.

In another example, if the at least one input signal comprises a plurality of input signals that are to be multiplied with each other, the individual measurement values may correspond to typical results for multiplying individual samples or individual portions of the input signals with each other.

The set of measurement data generated by the generative circuit 32 is further processed and/or combined by the DSP function circuit 34, thereby obtaining a set of expedited output data (step S7). In general, the set of expedited output data corresponds to the output data that can be obtained by processing the at least one input signal via the DSP sub-circuit 28 directly. However, the expedited output data can be obtained in a faster and more resource-efficient manner due to the classification and/or dimensional reduction performed by the signal encoding circuit 30.

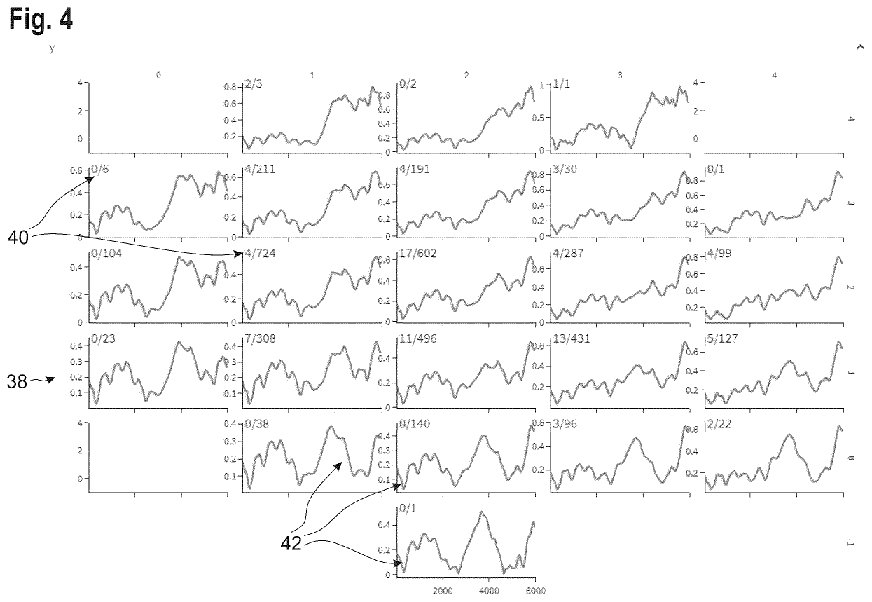

For the example case of visualizing the at least one input signal, the DSP function circuit 34 may combine the individual visualizations into a histogram 38 as illustrated in FIG. 4. The histogram 38 may further comprise labels 40 indicating how often the individual diagrams 42 have occurred.

If visualization data associated with individual input signals and/or portions of input signals has been obtained by the first signal path 22, the corresponding diagrams 42 may be explicitly highlighted in the histogram, e.g. by using a distinct color or label indicating that the corresponding input signal (portion) may be anomalous.

Summarizing, the DSP circuit 16 described above provides conventional DSP in the first signal path 22 as well as expedited DSP in the second signal path 24, such that all types of input signals can be processed reliably and in a fast and resource-efficient manner. Typical input signals having low entropy can be processed by the second signal path 24, providing a particularly fast and resource-efficient DSP. Exceptional and/or anomalous input signals can be processed by the first signal path 22, thereby ensuring correct processing for all types of input signals.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the test and/or measurement instrument 10, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions include applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The invention claimed is:

1. A digital signal processing (DSP) circuit, the DSP circuit comprising a signal input, a signal encoding circuit, a generative circuit, and a DSP function circuit,
wherein the signal input is configured to receive at least one input signal,
wherein the signal encoding circuit is configured to process the at least one input signal, wherein the signal encoding circuit is configured to map the at least one input signal to at least one signal characterization parameter,
wherein the generative circuit is configured to generate a set of measurement data based on the at least one signal characterization parameter, wherein the set of measurement data comprises at least one measurement value, and
wherein the DSP function circuit is configured to provide a DSP functionality, and wherein the DSP function circuit is configured to process and/or combine the set of measurement data, thereby obtaining a set of expedited output data.

2. The DSP circuit of claim 1, wherein the DSP functionality comprises at least one of visualizing the at least one input signal, applying arithmetic operations to the at least one input signal, applying mathematical operations to the at least one input signal, filtering the at least one input signal, or interpolating the at least one input signal.

3. The DSP circuit of claim 1, wherein the DSP circuit comprises a first signal path and a second signal path each being connected to the signal input,
wherein the first signal path is configured to provide said DSP functionality, wherein the first signal path is configured to process the at least one input signal, thereby obtaining a set of conventional output data, and
wherein the second signal path comprises the signal encoding circuit, the generative circuit, and the DSP function circuit.

4. The DSP circuit of claim 3, wherein the first signal path and the second signal path are arranged in parallel to each other.

5. The DSP circuit of claim 3, further comprising a control circuit, wherein the control circuit is configured to selectively activate the second signal path.

6. The DSP circuit of claim 5, wherein the control circuit is configured to determine an entropy parameter based on the at least one input signal.

7. The DSP circuit of claim 6, wherein the control circuit is configured to activate the second signal path if the entropy parameter determined is smaller than a predefined threshold.

8. The DSP circuit of claim 1, wherein the generative circuit is configured to generate the set of measurement data based on a lookup table.

9. The DSP circuit of claim 1, wherein the generative circuit comprise a machine-learning circuit, wherein the machine-learning circuit is pre-trained to generate the set of measurement data.

10. The DSP circuit of claim 9, wherein the machine-learning circuit comprises a decoder portion of an autoencoder.

11. A test and/or measurement instrument, the test and/or measurement instrument comprising a DSP circuit according to claim 1.

12. The test and/or measurement instrument of claim 11, wherein the test and/or measurement instrument is an oscilloscope, a signal analyzer, a vector network analyzer, or a spectrum analyzer.

13. A signal processing method of processing at least one input signal by a DSP circuit, the signal processing method comprising:
receiving, by a signal input, at least one input signal;
mapping, by a signal encoding circuit, the at least one input signal to at least one signal characterization parameter;
generating, by a generative circuit, a set of measurement data based on the at least one signal characterization parameter, wherein the set of measurement data comprises at least one measurement value; and
processing and/or combining, by a DSP function circuit being configured to provide a DSP functionality, the set of measurement data, thereby obtaining a set of expedited output data.

14. The signal processing method of claim 13, wherein the DSP functionality comprises at least one of visualizing the at least one input signal, applying arithmetic operations to the at least one input signal, applying mathematical operations to the at least one input signal, filtering the at least one input signal, or interpolating the at least one input signal.

15. The signal processing method of claim 13, wherein the DSP circuit comprises a first signal path and a second signal path each being connected to the signal input, wherein the first signal path is configured to provide said DSP functionality, wherein the second signal path comprises the signal encoding circuit, the generative circuit, and the DSP function circuit, and wherein the signal processing method comprises the step of selectively processing the at least one input signal by the first signal path or the second signal path.

16. The signal processing method of claim 15, wherein the second signal path is selectively activated by a control circuit.

17. The signal processing method of claim 16, wherein an entropy parameter is determined by the control circuit.

18. The signal processing method of claim 17, wherein the second signal path is activated if the entropy parameter determined is smaller than a predefined threshold.

19. The signal processing method of claim 13, wherein the set of measurement data is generated based on a lookup table.

20. The signal processing method of claim 13, wherein the generative circuit comprises a machine-learning circuit, wherein the machine-learning circuit is pre-trained to generate the set of measurement data.
